(19) United States
(12) Patent Application Publication
(10) Pub. No.: US 2003/0160182 A1
(43) Pub. Date: Aug. 28, 2003

(54) Apparatus and method for detecting fecal and ingesta contamination using a hand held illumination and imaging device

(75) Inventors: Jacob W. Petrich, Ames, IA (US); Thomas A. Casey, Ames, IA (US); Mark A. Rasmussen, McCallsburg, IA (US); Albin H. Gapsch, Melbourne, FL (US); Ricky Lee Flick, Merritt Island, FL (US); Richard D. Stroman, Indialantic, FL (US)

Correspondence Address: FOWLER WHITE BOGGS BANKER, P.A., 501 E. KENNEDY BOULEVARD, SUITE 1700, TAMPA, FL, 33602, US

(73) Assignee: eMerge Interactive, Inc.

(21) Appl. No.: 10/372,156

(22) Filed: Feb. 21, 2003

Related U.S. Application Data
(60) Provisional application No. 60/359,507, filed on Feb. 25, 2002.
(60) Provisional application No. 60/359,509, filed on Feb. 25, 2002.

(51) Int. Cl. G01N 21/64

(52) U.S. Cl. 250/458.1; 250/459.1; 250/461.1

(57) ABSTRACT

According to the present invention, there is disclosed a hand-held system and a method for detecting the presence of fecal contamination or ingesta on objects, such as a protein source, a worker's hands or utensils. In one embodiment, there is included a system comprised of a housing having a first end, where said housing supports a light source which emits light out of said housing first end having a wavelength effective to elicit fluorescence at a wavelength between 660 to 680 nm, and a light filter allowing the user to distinguish light at a wavelength between about 660 to 680 nm from any other light the vicinity of the object. The detection of light at a wavelength between about 660 to 680 nm indicates the presence of fecal contamination or other ingesta. There is also disclosed a method of using such a device to detect the presence of such contamination, optionally including further steps to identify the source of any contamination and to modify any practices so that the spread of contamination may be reduced.

### CROSS-REFERENCE TO RELATED APPLICATION

The present application claims the benefit of two previously filed co-pending Provisional Patent Application Serial Nos. 60/359,507 and 60/359,509, both filed Feb. 25, 2002.

### GOVERNMENT LICENSE RIGHTS

This invention was made, in part, with Government support under USDA/ARS CRADA Grant #58-3K95-M-764, USDA/CSREES Grant #99-34211-7379, USDA/CSREES Grant #99-34382-8351, and USDA/ARS Specific Cooperative Agreement #58-3625-7-113. The Government has certain rights in this invention.

### OBJECT OF THE INVENTION

A hand-held, lightweight and portable apparatus and method for detecting ingesta or fecal contamination on an object or surface using fluorescent spectroscopy is disclosed. The method and apparatus are particularly useful on protein sources such as beef, lamb, pork, chicken, turkey and the like, as well as any object that may come into contact with fecal matter. Specifically, a hand held device is used to emit UV or visible light having an appropriate wavelength onto the object to be examined, causing any feces or ingesta which may be present to fluoresce. Fluorescent light emissions having a wavelength between about 660 to 680 nm are then detected by a detector. The emission of fluorescent light having wavelengths between about 660 to 680 nm is an indication of the presence of ingesta or fecal material on the protein source, object or surface.

### FIELD OF THE INVENTION

The invention relates to an improved method and system for detecting fecal or ingesta contamination on an object or surface, such as food products, cooking or cutting utensils, food handlers, work surfaces or a protein source, using a lightweight or portable device using visible light fluorescent spectroscopy.

Microbial pathogens in food cause an estimated 6.5 million to 33 million cases of human illness and up to 9,000 deaths annually, according to the Council for Agricultural Science and Technology. Furthermore, the USDA Economic Research Service has recently reported that the annual cost of the food-borne illnesses caused by six common bacterial pathogens, Campylobacter spp., Clostridium perfringens, Escherichia coli 0157:H7, Listeria monocytogenes, Salmonella spp., and Staphylococcus aureus, ranges from 2.9 billion to 6.7 billion dollars (Food Institute Report, USDA, AER, December, 1996). The foods most likely to cause these illnesses are animal products such as red meat, poultry and eggs, seafood, and dairy products along with human fecal to oral.

Contamination of meat and poultry in particular with many bacterial food-borne pathogens often occurs as a result of exposure of the meat to ingesta and/or fecal material during or after slaughter, during shipment, at the retail store or even at the food preparation stage. Any of the above-mentioned pathogens can be transmitted to humans by consumption of meat and poultry contaminated in this manner. However, the contamination of meat with feces or ingesta is the primary source of contamination of meat and poultry with particularly onerous pathogens, including Campylobacter spp., Escherichia coli 0157:H7, and Salmonella spp.

Currently, the meat handling industry relies upon a variety of methods for the inspection of animal carcasses and portions thereof. These methods typically include human visual inspection, microbiological culture analysis, bioluminescent ATP-based assays, and antibody-based microbiological tests.

Fluorescence spectroscopy has been commonly used for the analysis of a variety of compounds, microorganisms, and tissues. The use of fluorescence spectroscopy for the detection of contaminants on foods has also been previously disclosed. For example, Alfano (U.S. Pat. No. 5,474,910) disclosed a method and apparatus for detecting biological molecules and microorganisms by irradiating the sample material with UV light at a wavelength between about 250 to 325 nm and measuring the resultant fluorescence. Alfano further disclosed that the process could be used for detecting the bacterial spoilage of food products, including meat and poultry. Unlike the disclosure in Alfano, which teaches a method that detects biological molecules and micoorganisms, the present invention instead teaches the detection of the presence of chlorophyl, or the host in which the bacteria lives, and does so by irradiating a sample material with light at a wavelength between about 380 nm and 470 nm rather than 250 to 325 nm. More recently, Waldroup and Kirby (U.S. Pat. Nos. 5,621,215 and 5,895,521) disclosed a method and apparatus for detecting the contamination of meat or poultry with ingesta or fecal material. As described therein, the meat or poultry is illuminated with UV light having a wavelength between about 320 to 420 nm, and examined for fluorescence.

There is also disclosed in U.S. Pat. No. 5,914,247 a method and apparatus for detecting ingesta or fecal contamination on an animal carcass in near real-time using fluorescent spectroscopy. As taught therein, the surface of the carcass is illuminated with UV or visible light having a wavelength between 300-600 nm, preferably between about 400 to 440 nm or between about 510 to 600 nm, and most preferably between about 410-430 nm and/or between about 520-540 nm, and fluorescent light emissions having a wavelength between about 660 to 680 nm are then detected. The invention taught by Casey et al is useful for detection of ingesta and fecal contamination during the high speed processing of animal carcasses in a slaughterhouse, and is particularly adapted to be used within a short time after slaughter. However, the device described in the '247 patent is not compact, lightweight, portable, inexpensive, or suited to the spot-checking of the hands of workers, or the objects which may come into contact with fecal matter or ingesta, but is instead directed at examination of meat products at high speeds in a slaughterhouse setting.

Unfortunately, many of these procedures are either labor intensive, time consuming, and insensitive, require large amounts of floor space, or are not cost effective on a small scale, and thus are inappropriate for the meat distribution and food preparation industries. Accordingly, there is a need for a low-cost and portable device which can quickly, objectively and accurately be used to detect whether protein sources, such as beef, lamb, pork, chicken, turkey and the like contain fecal contamination at locations other than the slaughterhouse, such as at grocery stores and restaurants.

There is also a need for a device and method that the meat processing and grocery industry can rely upon to objectively certify that their product is free of contamination. Such a device and method may be incorporated into a routine quality control process, such as a Hazardous Analysis Critical Control Point (HACCP) program or other system.

There is also a need for a device which can safely, quickly and accurately detect the presence of fecal matter on objects other than the protein source itself. For example, in the meat handling industry, the retail grocery industry, and the restaurant industry, there is a need for a device which can quickly and accurately detect whether fecal matter is present on objects such as knives, cutting boards or other objects which may come into contact with meat having fecal contamination. In order to be useful to small grocers, daycares or restaurants, such a device would also have to be affordable and small enough to fit within a minimal amount of space.

Likewise, in these industries, as well as in the child care industry, the geriatric care industry, or the medical industry, by way of example, there is a need for a device which can detect fecal contamination on the workers' hands, clothes or tools, and in so doing, can allow workers to take steps to remove such contamination.

The above applications would additionally benefit from such a device being lightweight and portable. This would allow the device to be held in the user's hand, mounted on a user's headgear, on counterbalance cables, or other mounting arrangements, such that the user's hands can be free to perform other activities. There is also a need for such a device to be battery driven and portable.

### SUMMARY OF THE INVENTION

We have now invented a novel and improved method and apparatus for detecting ingesta or fecal contamination on the surface of an object using visible light fluorescent spectroscopy. According to the present invention, using a lightweight, handheld device, the object is illuminated with UV or visible light having a wavelength effective to elicit fluorescence of feces at a wavelength between about 660 to 680 nm, which fluorescent light emissions having a wavelength between about 660 to 680 run are then detected by a detector. The emission of fluorescent light having wavelengths between about 660 to 680 nm is an indication of the presence of ingesta or fecal material on the protein source or other object.

In accordance with this discovery, it is an object of this invention to provide a handheld apparatus for detecting the presence of ingesta or fecal contamination on the surface of objects, including meat products such as such as beef, lamb, pork, chicken, turkey and the like, and the tools used to process them, to improve the safety of the food supply. It is also an object of the present invention to provide an apparatus and method to identify the area of contamination on a meat product for removal.

It is an object of the present invention to provide a device and method that the meat processing and preparing industries can rely upon to certify that their product is free of contamination. Such a device and method may be incorporated into a routine quality control process.

Another object of the invention is to provide an improved real-time method and lightweight and portable apparatus to detect fecal contamination on workers or objects which may come into contact with fecal matter. It is the intended object of the present invention to disclose an apparatus and method which can be used by workers coming into contact with fecal matter to identify such an occurrence and remove such contamination, as well as to take steps to modify their activities or processes to prevent such contamination in the future. It is intended that such industries as meat processing, healthcare, child care, and food sellers and preparers could use such a device.

Another object of the present invention is to provide safety features, which minimize the likelihood of user being exposed to the light emitted from the light emissions.

Another object of the present invention is to provide an integrated imaging system which can provide additional sensitivity over utilizing the human eye to detect the fluorescence of the fecal material.

Yet another object of the present invention is to provide an apparatus which meets the above needs and is affordable and small enough to fit within a minimal amount of space.

Other objects and advantages of the invention will become apparent from the ensuing description.

### BRIEF DESCRIPTION OF THE DRAWINGS

The following figures set forth various embodiments of the present invention:

FIG. 1 is a perspective view of a basic embodiment of the present invention.

FIG. 2 shows an alternative embodiment of the present invention in use, including a cone or similarly shaped filter used to aid in detecting light in the wavelength, range of interest and which will aid in protecting the worker from exposure to the blue emitted light.

FIG. 3 is a perspective view of a preferred embodiment in use illuminating a sample piece of meat.

FIG. 4 shows the configuration of the components within a preferred embodiment of the present invention, including: a light source or illumination system that illuminates the object of interest; a filter; a detection system; a processor such as a CPU; an LCD or monitor display; a result indicator; and an optional external network or employee identification reader.

FIGS. 5(a)-(d) show the illumination source and resulting emission spectrum created by the use of present invention to detect human stool resulting from a leafy green diet.

### DETAILED DESCRIPTION OF THE INVENTION

The process and apparatus of this invention may be used for detecting the ingesta or feces from any green-plant-eating animal or person that may be present on the surface of an object, such as on cuts of meat of wild or domestic meat producing animals, including but not limited to facultatively herbivorous or plant-eating mammals and birds such as bovine, poultry, porcine, ovine, caprine, equine, and ratites, especially cattle and calves, hogs, chickens, turkeys, sheep, and goats. It is to be understood that the word “object” as used in this Specification is meant to include both meat products and non-meat items.

Detection of ingesta and feces in accordance with this invention is based upon applicants' discovery that the ingesta and feces of plant-eating animals exhibit fluorescence at wavelengths between about 660 to 680 nm when illuminated with appropriate UV or visible excitation light, such as light having wavelengths between about 380-470 nm. This optical characteristic is ubiquitous in animals that consume plant material, particularly plant material containing photosynthetic pigments such as chlorophyll.

In its simplest form, the system of the present invention includes a lightweight excitation light source such as a lamp or laser for illuminating the surface of the object to be analyzed with UV or visible light having a wavelength effective to elicit fluorescence of feces at a wavelength between about 660 to 680 nm, and a detection source for observing fluorescent light emissions having a wavelength between about 660 to 680 run. In a preferred embodiment, this system is compact and lightweight, i.e., weighing less than three pounds, such that it can easily be held in the user's hand and be portable.

### EXAMPLE 1

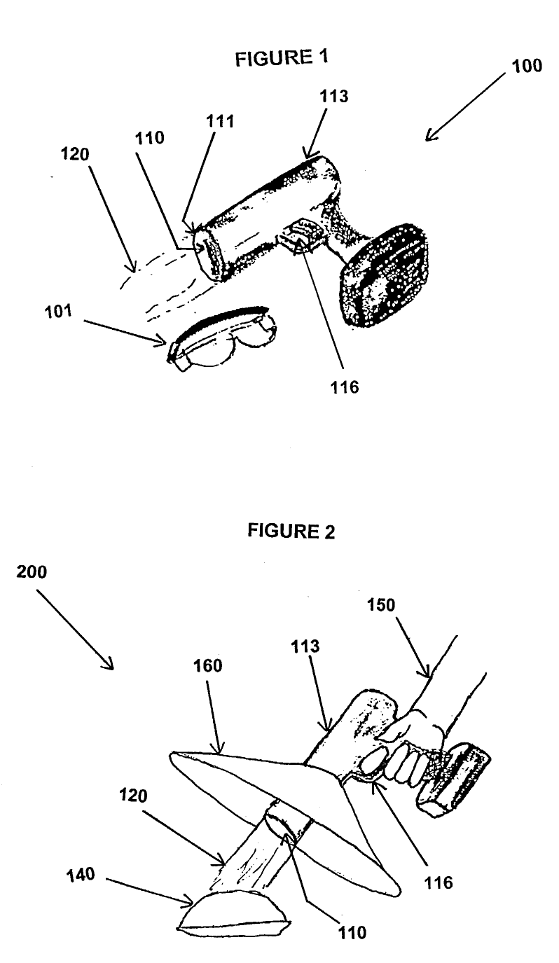

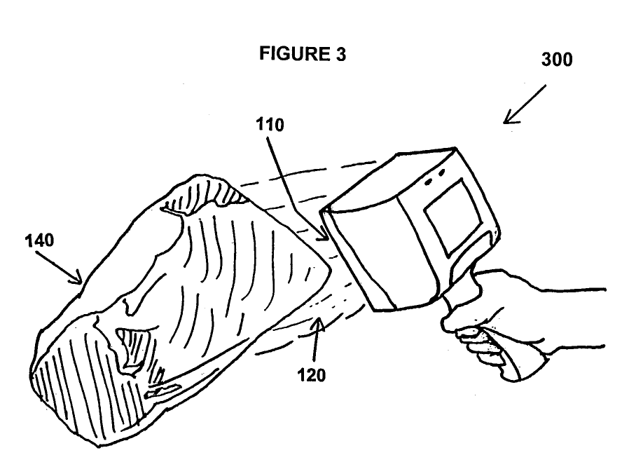

A basic embodiment of the present invention can be better understood with reference to FIGS. 1. This embodiment 100 includes a housing 113 supporting a light source 110, and can be used with a set of eyeglasses 101 that will reject light in the 320-540 nm range. Note that the set of glasses 101 used with a preferred embodiment are not physically attached to the light source 110. Emission light 120 can be created by an array of LED's, a mercury vapor lamp, fluorescent lamps or other illumination source. For ease of use, a preferred embodiment of the light source is gun-shaped.

In using this basic embodiment 100, the user 150 dons the set of glasses 101 and aims the emission light source 110 at the surface of the object to be examined for contamination. By depressing an activation mechanism 116, the system illuminates the object to be examined with blue light 120 in the 380-470 nm range. If fecal contamination or ingesta is present on the object, the feces will fluoresce at approximately 675 nm, +/−10 nm, where such fluorescence can then be visibly detected by the user wearing the glasses. Such fluorescence will appear red to the user's eye.

Upon detection of ingesta or fecal contamination, the object may be washed, disinfected or otherwise treated to remove ingesta or feces from the surface thereof. The process for detecting ingesta and feces on the washed surface may then be repeated, followed by additional washing and/or disinfection steps if necessary, until all traces of ingesta or feces have been removed or destroyed. A variety of wash solutions or disinfectants are known in the art and are suitable for use herein and include but are not limited to pressurized water or steam sprays, organic acids, chlorinated water, inorganic acids, detergents, and treatment with radiation. Once the object has been determined to be free of contamination as evidenced by the lack of fluorescence at the described range, the object may be returned to use, or prepared for consumption if the item is a food item, such as meat. The detection of ingesta or fecal contamination on the object also allows the user to adjust and improve upstream processing steps in order to prevent contamination wherever possible, and increase sanitation. When the present invention is used on meat, an additional benefit is an improvement in meat quality.

### EXAMPLE 2

In an alternative embodiment 200, as shown in FIG. 2, the user does not wear filtering glasses. Instead, the light emitting mechanism has an integrated filter element 160 which allows passage of the light indicating fecal contamination. Such element 160 can be mounted on the housing 113 of the light emitting system, or simply positioned at any point between the object to be examined and the detection system to be used. Thus, by way of example, when the detection system is the user's eye, the element would be mounted such that the user would view the object to be examined through the element. When mounted on the housing 113 of the light emitting system, we have found that a hemispherical or conical section is particularly practical for viewing the object 140 while the device blocks the blue wavelength light from the user.

### EXAMPLE 3

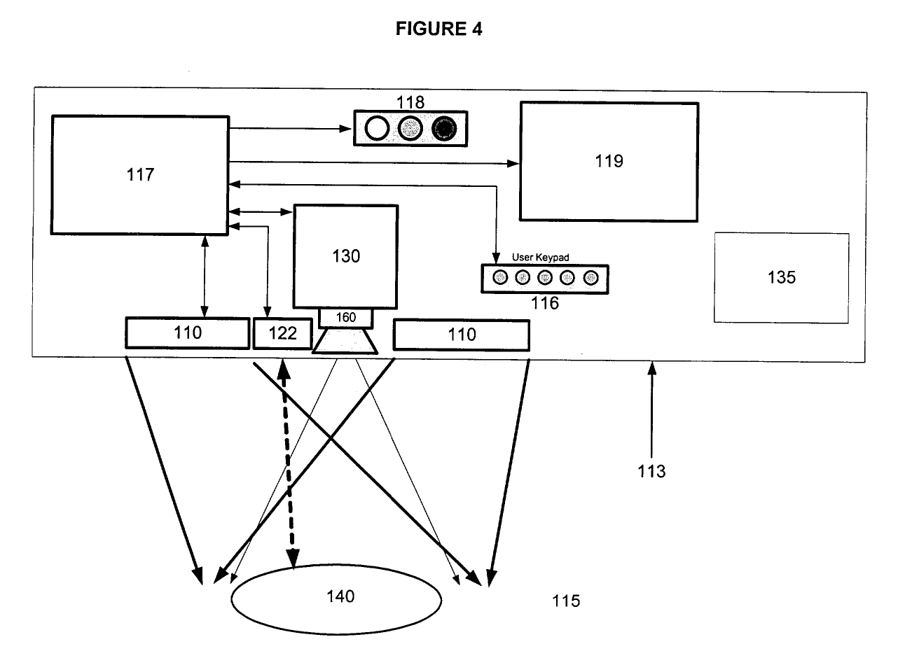

A preferred embodiment of the present invention is shown in FIG. 3300. The configuration of such a preferred embodiment is shown in FIG. 4, and includes a mounting structure 113 supporting a diffuse light source 110 capable of generating light in the 380-470 nm (blue) range. Emission light from light source 110 can be created by an array of LED's, mercury vapor lights, fluorescent lamps any other source well-known to those in the art to be capable of generating light in the appropriate range. In a particularly preferred embodiment, the light is emitted from an array of light emitting diodes with a peak emission wavelength of 420 nm which are positioned so as to permit illumination of the object of interest when the object is placed in the path of the emission light emitted from the first end 111 of supporting structure 113.

The preferred embodiment also includes a detection device 130 such as a photodetector or CCD sensitive to at least 660-680 nm light. Without being limited thereto, suitable photodetectors for use herein include photodiode detectors, photomultipliers, amplifiers or image intensifiers, CCD cameras, and photocathodes and microchannel plates (i.e. “Night vision” technology). One or more optical filters 160 are preferably positioned between the object to be detected 140 and the photodetector to selectively transmit light in the range of about 660-680 nm light, while preventing transmission of back-scattered excitation light. Filters are preferably effective to remove wavelengths of light less than about 660 and greater than about 680 nm.

A processor 117, such as a CPU, controls the operation of the system, including receiving signals from an activation device 116, such as a user keypad. Processor 117 receives a signal from the detection device 130 and transmits it to a result indicator 118, or a display monitor 119, or an external network or employee ID reader (not shown), or any combination thereof. Indicator 118 may include a signal for when the fluorescent intensity at the measured 660-680 nm range has exceeded a predetermined threshold value. Signals may include for example, audible alarms, visible lights or LEDs, or any combination of the above. Thus, as taught herein, the present invention may aid in objectively identifying the presence of contaminant. The entire system is powered by a power source 135, such as a battery or power cord connected to a utility.

A proximity sensor 122 may also be optionally used to ensure that an object is in fact present in the emission light path 115 of the present invention before the light source will be activated. Specifically, such object sensing device 122 or proximity sensor may provide for electronic control of the light emissions, such that light will not be emitted from the light source unless an object to be examined is within the light path 115, or alternatively, within a certain specified distance from the light source. Such use of a distance sensor and affiliated circuitry provides for increased safety to the user and others in the vicinity in that the device will not be activated except when there is an object 140 present for detection, thus providing the increased benefit of reducing any unintended and thus unnecessary exposure to the light source 110. Object sensing technologies appropriate for such an embodiment would be well-known to those in the distance-sensing art and would include, by way of example only, infrared and ultrasonic proximity-sensing or photo-electric technologies. The circuitry for creating such a safety mechanism is also well known in the art.

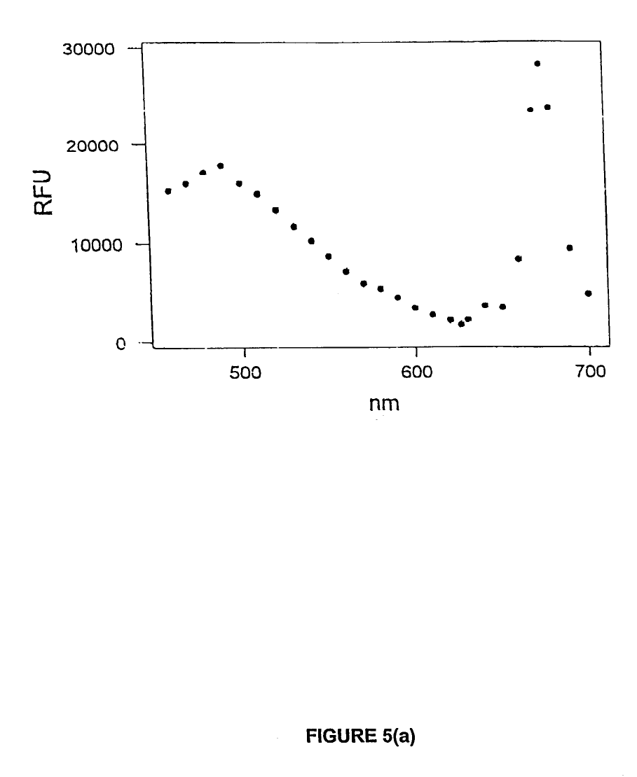

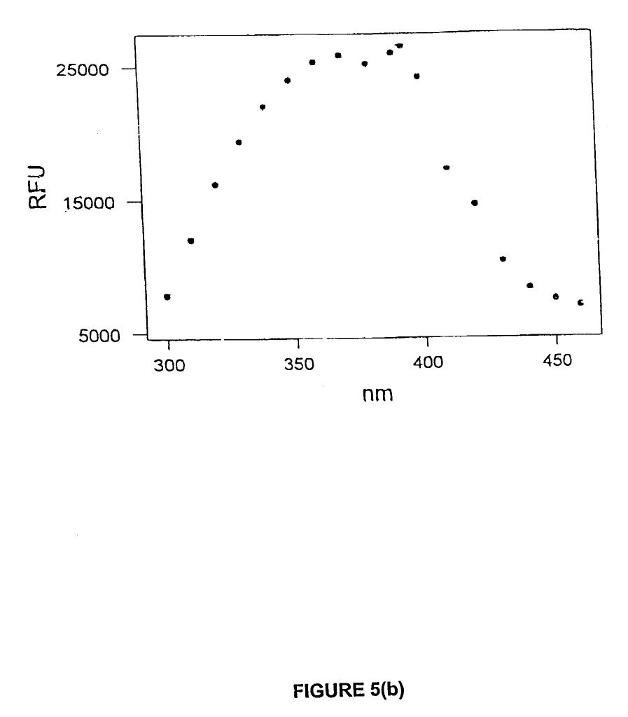

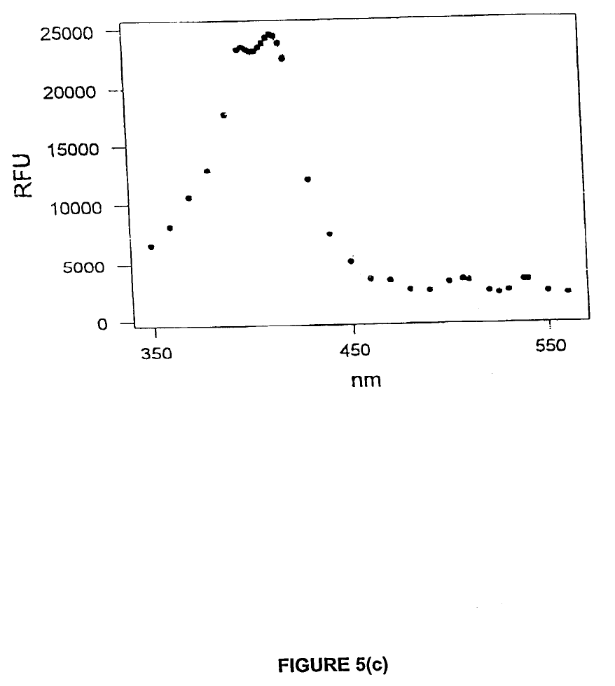

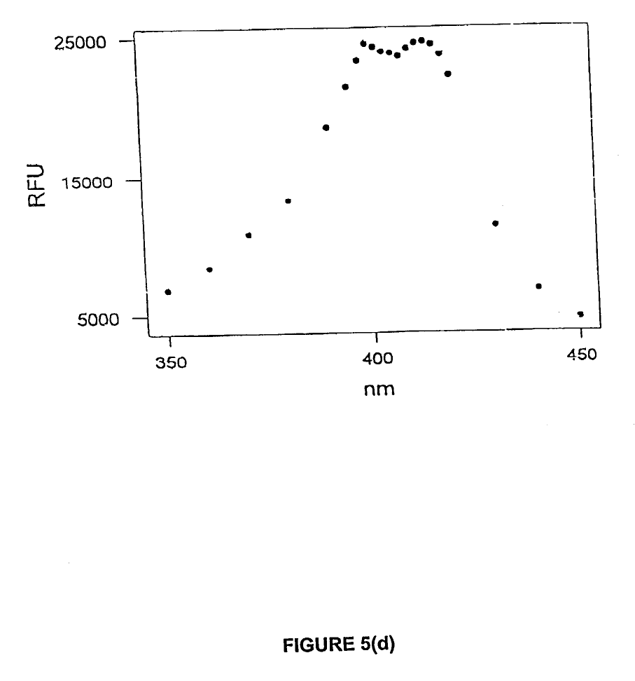

In an alternative embodiment, the output signal from the photodetector may be relayed to a recording instrument, such as an oscilloscope, desktop computer, hard drive, printer or any other device known in the art for presenting or storing a graphical display of fluorescent spectra intensity. For example, FIGS. 5(a)-(d) depict the illumination source and resulting emission spectra created by the use of present invention connected to a printer. Note that the spectra in FIGS. 5(a)-(d) depict the use of the present invention used to detect human stool resulting from a leafy green diet.

It is understood that the foregoing detailed description is given merely by way of illustration and that modifications and variations may be made therein without departing from the spirit and scope of the invention.

What is claimed is:

1. A portable system for detecting the presence of ingesta or fecal matter on the surface of an object, the system being light enough to be supported by a user's hand during use, comprising:
a) a housing;
b) a light source;
c) said housing supporting said light source;
d) said light source emitting light;
e) said emitted light having a wavelength effective to elicit fluorescence from the ingesta or fecal matter at a wavelength between about 660 to 680 nm.
f) a light filter;
g) said light filter being positioned between the user and the object to be examined; and,
h) said light filter allowing the user to distinguish fluorescent light from the object at a wavelength between about 660 to 680 nm from other light.

2. The system of claim 1, wherein:
said light filter comprises the lenses on a pair of glasses to be worn by the user.

3. The system of claim 1, wherein:
said light filter is located on said housing so as to allow the user to view the object to be examined through said filter when using the system.

4. A portable system for detecting the presence of ingesta or fecal matter on the surface of an object, the system being light enough to be supported by a user's hand during use, comprising:
a) a supporting structure having a first end;
b) a light source;
c) said supporting structure supporting said light source;
d) said light source emitting light out said supporting structure first end;
e) said emitted light having a wavelength effective to elicit fluorescence from the ingesta or fecal matter on the object at a wavelength between about 660 to 680 nm;
f) a light detection device;
g) said light detection device being positioned so as to detect fluorescence light emissions from the object to be examined;
h) said light detection device detecting fluorescent light emissions having a wavelength between about 660 to 680 nm from the object surface;
i) a light filter;
j) said light filter being at least partially positioned between said light detection device and the object to be examined;
k) said filter substantially filtering out light other than light at a wavelength between about 660 to 680 nm;
l) a processor;
m) an indicator;
n) said processor being in communication with said light detection device; and
o) said processor transmitting a signal between said light detection device and said indicator.

5. The system of claim 4, wherein:
said light source emits light at a wavelength between about 380 to 470 nm.

6. The system of claim 5 where said light source includes a laser, an array of LEDs, a mercury vapor light source, or fluorescent lamps.

7. The system of claim 4, wherein said light detection device includes a photodetector or a CCD.

8. The system of claim 7 wherein said photodetector comprises photodiode detectors, photomultipliers, amplifiers, image intensifiers, CCD or CMOS cameras, photocathodes, or microchannel plates.

9. The system of claim 4 wherein said filter substantially filters out light in the range between about 320 to 540 nm and above about 680 nm.

10. The system of claim 4 further comprising a viewing lens or display screen in communication with said processor.

11. The system of claim 4 further comprising a recording instrument in communication with said processor.

12. The system of claim 11 wherein said recording instrument includes an oscilloscope, a desktop computer, a hard drive, or a printer.

13. The system of claim 4 wherein said indicator is an audible alarm, visible lights, LEDs, or any combination thereof.

14. The apparatus of claim 4 further comprising a means for detecting the presence of an object to be examined.

15. The apparatus of claim 14, further comprising:
a) a means for preventing said light source from emitting light;
b) wherein said means for preventing prevents said light source from emitting light unless said means for detecting detects the presence of an object to be examined.

16. The system of claim 14, wherein said means for detecting includes infrared proximity sensing, ultrasound proximity testing, or photo-electric testing.

17. The system of claim 4 where said light source is powered by one or more batteries or current supplied through a power cord.

18. The system of claim 11 further comprising:
a) a signal generator;
b) said signal generator being in communication with said processor;
c) wherein said signal generator generates a signal where said signal indicates that said photodetector has detected a fluorescent intensity at about 660 to 680 nm which exceeds a threshold value.

19. A portable system for detecting the presence of ingesta or fecal matter on the surface of an object, the system being light enough to be supported by a user's hand during use, comprising:
a) a supporting structure having a first end;
b) a light source;
c) said light source comprising light emitting diodes in an array;
d) said supporting structure supporting said light source;
e) said light source emitting light out said supporting structure first end at about 420 nm;
f) said emitted light having a wavelength effective to elicit fluorescence from the ingesta or fecal matter on the object at a wavelength between about 660 to 680 nm;
g) a light detection device;
h) said light detection device being positioned so as to detect fluorescence light emissions from object to be examined;
i) said light detection device detecting fluorescent light emissions having a wavelength between about 660 to 680 nm from the object surface;
j) a light filter;
k) said light filter being at least partially positioned between said light detection device and the object to be examined;
l) said filter substantially filtering out light other than light at a wavelength between about 660 to 680 nm;
m) a processor;
n) an indicator;
o) said processor being in communication with said light detection device; and
p) said processor transmitting a signal from said light detection device to said indicator.

20. A method for detecting the presence of ingesta or fecal matter on the surface of an object, comprising the steps of:
a) illuminating the object with light emitted from a hand-held system, wherein said system is comprised of a housing supporting a light source which emits light having a wavelength effective to elicit fluorescence from the ingesta or fecal matter at a wavelength between 660 to 680 nm; and
b) detecting fluorescent light emission from the surface of the object at a wavelength between about 660 to 680 nm, wherein detection of fluorescent light emission at said wavelength between about 660 to 680 nm is an indication of the presence of ingesta or fecal material on said surface.

21. The method of claim 20 wherein the method further comprises washing or decontaminating the object when said detecting step results in any fluorescent light emission from said object at a wavelength between about 660 to 680 nm being detected.

22. The method of claim 21 wherein said washing or decontaminating step is performed using a wash solution including pressurized water, steam, organic acids, chlorinated acids, inorganic acids, and detergents, or any combination thereof.

23. The method of claim 21 further comprising repeating said illuminating and detecting steps and washing or decontaminating steps until no fluorescent light emission having a wavelength between about 660 to 680 nm is detected.

24. A method for reducing the spread of ingesta or fecal contamination by a worker from an object to other workers or other items in a workplace, comprising the steps of:
a) illuminating the object with light emitted from a hand-held system, wherein said system is comprised of a housing supporting a light source which emits light having a wavelength effective to elicit fluorescence from the ingesta or fecal matter at a wavelength between 660 to 680 nm; and
b) detecting fluorescent light emission from the surface of the object at a wavelength between about 660 to 680 nm, wherein detection of fluorescent light emission at said wavelength between about 660 to 680 nm is an indication of the presence of ingesta or fecal material on said surface;
c) preserving the results of the detecting step for later review;
d) reviewing the preserved results of the detecting step to identify trends relating to contamination; and
e) taking corrective action based upon the trends to reduce the instances of continued handling of contaminated objects.
